(19) United States
(12) Patent Application Publication
(10) Pub. No.: US 2011/0229749 A1
(43) Pub. Date: Sep. 22, 2011

(54) Advanced Vehicle Battery Cooling/Heating System with Varying Hydraulic Diameter

(75) Inventors: Gi-Heon Kim, Golden, CO (US); Ahmad Pesaran, Boulder, CO (US); Matthew Allen Keyser, Arvada, CO (US)

(73) Assignee: Alliance For Sustainable Energy ,LLC, Golden, CO (US)

(21) Appl. No.: 13/130,707

(22) PCT Filed: Nov. 24, 2008
(86) PCT No.: PCT/US2008/084490

§ 371 Date: May 23, 2011

(51) Int. Cl. H01M 10/50

(52) U.S. Cl. 429/120

(57) ABSTRACT

A battery cooling system (100) is provided to maintain more uniform temperature distribution in vehicle batteries (142). A battery (142) is provided with at least one exposed cell surface (143). A cooling shell (146) is provided with an interior surface spaced apart from the exposed cell surface (143). The interior surface defines a flow channel (147) for cooling fluid (150) such as air (114) provided by a system fan (112), and the air (150) flows in direct contact with the cell surface (143) from an inlet to an outlet of the channel (147). The channel (147) has a first hydraulic diameter at the inlet that is greater than a second hydraulic diameter at the outlet to the channel (147). The hydraulic diameter is varied or decreased along the length of the channel (147) such that the system provides a first surface heat transfer coefficient proximate to the channel inlet that is less than a second surface heat transfer coefficient proximate to the channel outlet.

### CONTRACTUAL ORIGIN

The United States Government has rights in this invention under Contract No. DE-AC36-086028308 between the United States Department of Energy and the Alliance for Sustainable Energy, LLC, the Manager and Operator of the National Renewable Energy Laboratory.

### BACKGROUND

Recently, there has been a large and rapidly growing interest in advanced vehicles for a variety of reasons including oil shortages, increased prices for gasoline, and environmental concerns. Advanced vehicles are typically powered at least part of the time by electricity and include hybrid electric vehicles (HEVs), plugin hybrid electric vehicles (PHEVs), electric vehicles (EVs), and fuel cell vehicles. HEVs and PHEVs are attractive because they reduce emissions and pollution and also provide significantly higher fuel economy because an onboard battery or battery pack with a set of batteries drives an electric motor at least part of the time to reduce the need or load on the engine. The batteries of HEVs are charged during operation of the vehicle while PHEVs may be charged by plugging the vehicle such as at home, at an office, or the like. EVs and fuel cell vehicles run solely on electricity provided by the batteries or fuel cells and, hence, vehicle developers interested in reducing emissions and use of gasoline find these advanced vehicles particularly attractive in the long term.

One of the biggest challenges facing advanced vehicle designers is the battery or battery system and how to provide reliable batteries with high charge capacity and reliable operation. Additionally, the batteries of advanced vehicles may represent a large portion of the vehicles overall cost with a typical battery pack, e.g., up to 10 to 50 or more percent of the vehicle cost. A PHEV or EV may include a battery pack with a few larger batteries such as lithium ion batteries that are cylindrical or prismatic (e.g., rectangular in cross section) or a battery pack or module with a larger number of smaller batteries in parallel such as 10 to 50 or more batteries. With batteries costing hundreds to thousands of dollars apiece, it is becoming more and more important for the service life of each battery to be many years (e.g., the expected life of the vehicle such as around 15 years) rather than being changed out periodically as with conventional vehicle batteries.

In general, a vehicle battery is a device for storing and releasing electric energy via chemical reactions; and the service life of the battery is increased when these chemical reactions occur relatively uniformly within the battery. Temperature has a significant impact on performance and life of batteries. At low temperatures, the impedance of the battery is high while the efficiency is low, and this may cause the vehicle to operate improperly. At higher temperatures, the batteries degrade faster, which leads to a shorter battery life and higher life cycle cost. Unfortunately, temperature variances are common for batteries in present advanced vehicle designs, and this non-uniformity of temperature causes degradations in the performance and life of the batteries or cells. For example, studies have indicated that a temperature difference of 18° C. across a battery or cell may result in a 20 percent difference in local current production, and such variance in use of the battery may cause the portion that is more productive to have a shorter service life as well as causing other performance problems. Recent advanced vehicle designs have included larger cells or batteries, and the impacts of non-uniformity of temperatures and/or spatial distributions can be an even more significant problem in larger cells than in smaller cells. Hence, there is a need for managing temperatures within advanced vehicle batteries or battery packs to try to achieve more uniform temperature distributions, and this problem likely will become more pronounced with the push toward PHEV and EV vehicles that employ expensive, high volume battery packs.

Air cooling has generally been preferred for advanced vehicles because of simplicity and lower cost, but use of air cooling is not always effective and has made it difficult to manage battery temperatures. Liquid cooling may be used in some cases to provide more effective cooling and better temperature distribution, but air cooling is preferred because it is less costly, less complicated to design and operate, and allows direct contact cooling whereas liquids have to be separated from the battery. A typical cooling system for a vehicle battery includes one or more fans for moving ambient (or pre-cooled) air over one or more outer surfaces of the battery or the batteries in a pack or module. The air flows in a channel or passageway such as a rectangular passageway on a side of the batteries or a cylindrical passageway about the external sides of a cylindrical battery or cell. The air enters the passageway or cooling channel at a first end at a first temperature and as the air passes over the battery or cell external surfaces it rapidly accepts heat due to its small heat capacity value.

As a result, the air exits a second end of the passageway or channel at a second temperature that is typically much higher than the first or inlet temperature. Since the temperature difference between the battery and flowing air is decreased, portions of the battery nearer the second end passageway or channel outlet are typically not as effectively cooled, which results in a non-uniform temperature distribution within the battery that can negatively effect the service life of the battery. Some air-based battery cooling systems have attempted to provide more uniform cooling and temperatures by varying the contact surface between the air and the battery, e.g., by increasing the area available for the air to contact the batteries from the inlet to the outlet such that more of the higher temperature air is available to transfer heat from the battery near the airflow passageway outlet. Such designs have not been widely adopted in part because it is typically desirable to maximize the contact area between the flowing air and the batteries external surface to increase heat transfer from the battery. Hence, vehicle and battery manufacturers remain interested in finding an improved cooling system for batteries and battery packs for use in advanced vehicles and other applications to better maintain or approach a uniform temperature distribution within the battery cells.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods that are meant to be exemplary and illustrative, not limiting in scope. In various embodiments, one or more of the above-described problems have been reduced or eliminated, while other embodiments are directed to other improvements. Note, too, that the following discussion includes specific examples highlighting features of a thermal management system for energy storage devices that are useful for cooling batteries and other energy storage devices. However, these are not intended to be limiting examples but instead are merely illustrative of a particular type of thermal management system. For example, it may be desirable to use the teaching of a thermal management shell to provide a cooling shell and/or to provide a heating shell, and this may be achieved generally by directing a flow of a fluid (such as air) that is at a lower or at a higher temperature than the device (or its surfaces) through a channel of the shell. As explained below, the channel typically has a first hydraulic diameter at a first or inlet end that is greater than a second hydraulic diameter at a second or outlet end of the shell channel.

In a cooling example of thermal management, battery cooling systems and channel designs are provided that are able to achieve better uniformity of temperature distribution in an object such as a vehicle battery. When a relatively low heat capacity heat transfer fluid (e.g., air or the like) is used for cooling a battery, such as large lithium ion battery for an advanced vehicle, it had proven difficult to provide uniform temperature distribution with cooling channels having a constant height or diameter (e.g., a constant or uniform hydraulic diameter). In part, the temperature of the battery varied because there was a significant temperature change of the cooling fluid inside the system or from an inlet end of the channel to the outlet end of the channel. Non-uniform temperature distributions are a critical problem for controlling battery life and performance. To this end, the battery cooling system and cooling channel designs described herein include a variable cross-section heat transfer fluid or cooling channel for directing air or other fluid coolant over the battery for direct contact cooling that is more uniform along the length of the channel (or over the surfaces of the battery or other cooling surfaces). In some embodiments, the change or differential of battery surface temperature at cooling fluid inlet to cooling fluid outlet is better controlled (e.g., the temperature difference is reduced along the battery's heat transfer surface) by changing the hydraulic diameter of the cooling channel (or airflow passageway) along the length of the cooling surface to make the heat transfer coefficient (h) increase in the flow direction of the cooling fluid (or air flow from channel inlet to outlet).

In an exemplary cooling channel, the heat transfer coefficient is increased along the length of the cooling channel by decreasing a channel cross-sectional dimension such as the hydraulic diameter (e.g., channel height for a rectangular cross section channel, channel diameter for a circular cross section channel, and so on). The heat transfer surface area or cooling surface area on the battery typically is kept constant, but some embodiments may combine a decreasing hydraulic diameter with an increasing cooling surface area such as by increasing width of the channel nearer to the channel outlet) to achieve a desired cooling effect (e.g., a more uniform temperature distribution in a battery). Increasing the heat transfer coefficient within a cooling channel used to cool a battery or cell is believed to be more effective in direct contact cooling systems (e.g., systems where the cooling fluid contacts a surface to be cooled) that use a fluid such as air with lower thermal conductivity and heat capacity. The heat transfer coefficient (h) is sensitive to channel cross-section dimensions such as the hydraulic diameter especially when the thermal conductivity of the heat transfer or cooling fluid is small and thermal resistance between the object surface (e.g., battery surface) and cooling fluid is negligible (e.g., a direct air cooling application but not that the concepts described herein may also be applied to other fluids that may or may not be used in direct contact applications).

More particularly, a battery cooling system is provided for use in advanced vehicles and other applications to provide improved temperature distribution (e.g., more uniform cell surface temperature). The system includes a fan moving cooling fluid such as ambient or cooled air or the like at a volumetric flow rate through the system. A battery or battery pack is provided with at least one exposed cell surface. A cooling shell (which may be part of the battery housing or tray or a separate component) is provided with an interior surface or wall spaced apart a distance from the exposed cell surface. The interior surface defines a channel or flow passageway for the cooling fluid to flow at the flow rate over the cell surface from an inlet to an outlet of the channel. The interior surface is configured such that the channel has a first hydraulic diameter at the inlet that is greater than a second hydraulic diameter at the outlet to the channel. In some embodiments, the hydraulic diameter is varied or decreased along the length of the channel while the contact or cooling surface of the cell is held constant or is uniform along the channel (e.g., to hold heat transfer relatively constant along the channel by maintaining the area with increasing heat transfer coefficient and narrowing surface and cooling fluid temperature difference).

In some embodiments, the cooling fluid is air that enters the channel at or near the inlet at a first temperature and is discharged from the channel at or near the outlet at a second higher temperature. The cooling system is characterized by a first surface heat transfer coefficient proximate to the inlet of the channel that is less than a second surface heat transfer coefficient proximate to the outlet of the channel. For example, the first surface heat transfer coefficient may be 50 percent or more smaller than the second surface heat transfer coefficient, whereby the cell surface temperature may have a relatively small differential from the inlet to the outlet of the channel (e.g., less than about 4° C. difference with the exit/outlet area, of course, being greater in temperature).

The channel may be thought of as having a plurality of hydraulic diameters along the length of the channel and these hydraulic diameters decrease in magnitude or value from the inlet to the outlet of the channel (e.g., linearly with increasing distance from the inlet or in a non-linear manner in some cases). In other words, the channel has a cross sectional shape (e.g., rectangular, circular, or the like) with a first area near the inlet and typically a similar cross sectional shape near the outlet but with a second area smaller than the first. Such cross sectional shapes may be defined by a height or distance measured from the cell surface to the interior surface of the cooling shell that defines the channel “top side” and the height is greater at the inlet than at the outlet (such as 2 to 5 times or more greater or a reduction in height along the channel of up to 80 percent or more). The first and second hydraulic diameters may be chosen such that the surface heat transfer coefficient, which increases or is varied along the flow direction or with increasing distance from the channel inlet, is less than about 50 percent at the inlet area than at the outlet area of the channel (e.g., the surface heat transfer coefficient, h, may be 2 times or more greater toward the outlet end of the tunnel than near the inlet where the air or other cooling fluid temperature is lower).

In addition to the exemplary aspects and embodiments described above, further aspects and embodiments will become apparent by reference to the drawings and by study of the following descriptions.

### BRIEF DESCRIPTION OF THE DETAILED DRAWINGS

Exemplary embodiments are illustrated in referenced figures of the drawings. It is intended that the embodiments and figures disclosed herein are to be considered illustrative rather than limiting.

FIG. 1 illustrates schematically a battery cooling system for use in PHEV, EV, and other advanced vehicles;

FIG. 2 illustrates in a simplified manner a side view of a cell and cooling channel arrangement of a prior art battery cooling system with a conventional constant hydraulic diameter cooling channel;

FIG. 3 illustrates a side view similar to FIG. 2 of a cell and cooling channel arrangement of a battery cooling system as described herein with a cooling channel with a varying (or non-uniform) hydraulic diameter to provide a variable heat transfer coefficient along the length of the battery or batteries within a battery pack or array;

FIG. 4 is a graph of the surface heat transfer coefficient for cooling fluid or air along a battery or pack surface in the constant hydraulic diameter arrangement of FIG. 2 and for the varying hydraulic diameter arrangement of FIG. 3;

FIG. 5 is a graph showing measured cell surface temperature along a battery cell surface during operation of the cell and cooling channel arrangements of FIGS. 2 and 3;

FIGS. 6A and 6B illustrate section and end views of a cell and cooling shell/jacket arrangement with a cooling channel or passageway provided about exterior surfaces of a cylindrical battery or cell and having a varying (e.g., decreasing) hydraulic diameter along the length of the cell from an air inlet to an air outlet;

FIG. 7 illustrates a partial sectional, side view of a cell and cooling shell/jacket arrangement with a cooling channel defined for air flow by an inner surface of the cooling shell wall and having a nonlinear reduction of the hydraulic diameter to facilitate tuning of the heat transfer coefficient to control temperature distributions in the cell; and

FIG. 8 illustrates a side view similar to FIG. 3 of a cell and cooling/heating channel arrangement of a thermal management system as described herein with a heat transfer channel with a varying (or non-uniform) hydraulic diameter to provide a variable heat transfer coefficient along the length of the energy storage device(s) such as prismatic batteries within a pack or array.

### DESCRIPTION

The following provides a description of exemplary battery cooling/heating systems (or thermal management systems) for advanced vehicles such as EVs, PHEVs, HEVs, fuel cell vehicles, and the other vehicles and other applications for which it is desirable to maintain a more uniform temperature distribution within a battery or cell of a battery pack. The battery cooling/heating systems described below are configured with channels or passageways for air or other small thermal conductivity fluids provide on one or more sides of a battery or cells of a battery pack/module. The channels provide more uniform cooling/heating with a particular flow of fluid such as air by providing cross sectional area dimension that decreases from the air inlet (where the air temperature is lower/higher) to the air outlet (where the air temperature is higher/lower) of the channel. Specifically, the hydraulic diameter is typically greater at the air inlet than at the air outlet, and this dimension may be decreased linearly along the channel length or it may be tuned to decrease in some other manner (e.g., the sidewalls of defining the channel may be tapered or curved according to a parabolic or other function when viewed in a side view of the channel). Significantly, the hydraulic diameter is varied in an attempt to vary the heat transfer coefficient of the cooling/heating fluid such that it is lower or smaller at initial or earlier stages or portions of the cooling/heating channel and higher or larger at final or later stages or portions of the cooling/heating channel. In this manner, a more uniform cooling/heating is achieved for a heat transfer surface (e.g., an exterior surface or casing of a battery or cell) and a better or more uniform temperature distribution can be achieved for a battery or cells in a battery pack or similar object such as another energy storage device such as an ultra-capacitor or the like.

It is recognized that air cooling (or cooling with a similar fluid) is generally a preferred technique for cooling batteries within advanced vehicle applications. When compared with liquid cooling, air cooling provides lower costs, less complex systems, and fewer system parts. However, air cooling is less effective or efficient than liquid cooling and presents a number of challenges associated with this lower effectiveness. As a thermal fluid, air has a small heat capacity such that during cooling a surface it rapidly increases in temperature. Air also has a low heat transfer or exchange coefficient (h) due to its small thermal conductivity (k) (e.g., h=(Nu)(k)/(Dₕ) where NU is the Nusselt number and Dₕ is hydraulic diameter (which can be defined for nearly any cross sectional shape of a flow path and may be diameter for a circular cross section, a height for a rectangular cross section, and so on but its use is generally intended to cover the broad concept of a cross section dimension used to define the cross sectional area of nearly any flow channel or passageway although the specific formula will vary for differing cross sectional shapes). Air is favorable for use in cooling electrical devices such as batteries as it is dielectric, which facilitates the use of air in direct-contact cooling systems. Another issue with cooling with air, though, is its high viscosity that can lead to significant pressure drops when flow is restricted, which in turn can require increases in fan size or number to draw or push air through a cooling channel or flow path.

The inventors recognized that surface temperature of a cooled object such as a battery is sensitive to hydraulic diameter of the cooling channel or passageway in air-based cooling systems because of the low or small thermal conductivity. The temperature difference between the coolant (e.g., air) and a battery or cell surface rapidly increases with hydraulic diameter when compared with other coolants such as water/glycol and mineral oil due to air's small thermal conductivity. Further, the inventors recognized that the heat transfer coefficient is also sensitive to hydraulic diameter in a direct cooling system such as an air system while liquids such as mineral oil and water/glycol do not experience much variance in the heat transfer coefficient with changes in the hydraulic diameter of the passageway.

The inventors used this knowledge of the thermal properties of air and their understanding of batteries and growing importance of uniform temperature distributions in later generation vehicle batteries to discover or recognize that, although prior air cooling systems use a constant cross section cooling channel to cool batteries, the hydraulic diameter, D₁₁, of a cooling or coolant channel is a very sensitive design parameter that can be successfully used to control performance of an air-based cooling system. As will become clear with the following exemplary embodiments of battery cooling systems, the idea of decreasing the hydraulic diameter (or a cross section-varying dimension such as height or diameter) is used to provide an increasing heat transfer coefficient for the flowing fluid, which typically will be air or other fluid with similar heat transfer properties. Such an increasing heat transfer coefficient, h, with increasing distance from the air inlet or channel inlet helps to alleviate non-uniformity of the battery surface temperature (e.g., instead of a 4 to 8° C. temperature variance from inlet portions of the battery surface area to outlet portions of the battery surface area temperature variances in the cell may only be 1 to 4° C. or the like or improvements of up to 20 to 40 percent or more). Again, the above discussion is applicable to air heating, too, and the following discussion highlights cooling systems/techniques but is equally applicable to heating systems (e.g., the term “cooling” may be replaced or used interchangeable with the “heating” but the discussion stresses cooling for ease of explanation and to simplify the description for the reader).

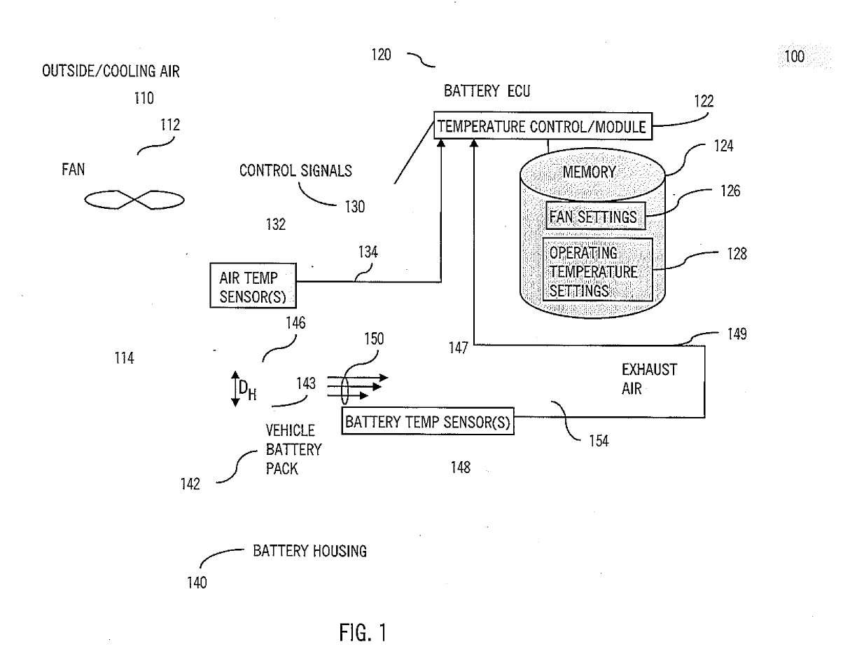

With these ideas in mind, FIG. 1 illustrates a battery cooling system 100 such as may be provided in an advanced vehicle in which uniform temperature distribution is desired for controlling service life and performance. For example, an PHEV or EV in which a relatively large and/or expensive set of batteries or cells such as lithium ion or the like are provided in a vehicle battery pack 142 (e.g., the term battery pack is intended to mean a single chemical cell or battery with multiple cells or a plurality of such cells and/or batteries combined in parallel or series to store and discharge electricity). The vehicle battery pack 142 is mounted and/or supported within a battery housing 140, which in turn typically is mounted within the vehicle structure or frame such as in the trunk or other location. According one important aspect of the system 100, a cooling jacket or shell 146 is provided adjacent to or as part of the housing 140 so as to define a cooling channel or coolant flow passageway 147 between an inner surface and one or more surfaces 143 of the battery pack 142. As shown, the cooling channel or passageway 147 has a cross sectional shape defined by the inner surface of the jacket or shell 146 that has a hydraulic diameter, Dₕ, that decreases from the inlet to the outlet of the passageway 147 (e.g., decreases with increasing distance from the inlet to the channel or along the cell surface 143). As will be explained in detail below, such a shaped channel 147 causes the coolant (e.g., air) to have a varying and, generally, increasing heat transfer coefficient along the surface 143 to better distribute cooling along this surface (rather than providing significantly better cooling near the air inlet of the passageway 147).

The cooling system 100 includes a fan (or fans) 112 for drawing outside or other cooling air 110 into the system 100 and for forcing inlet air 114 at a first temperature into the inlet end of the air passageway 147 of the cooling jacket 146. As the air 150 flows over the cell surface 143, heat is transferred from the battery pack 142 to the air 150 such that air 154 ejected from the outlet of the cooling channel 147 is at a higher temperature than inlet air 114. To equalize (or reduce non-uniformity) heat transfer to the air 150, the hydraulic diameter, Dₕ, is reduced along the surface 143 from the channel inlet to the channel outlet such that heat transfer coefficient of the air 150 increases along the length of the channel 147 or as the distance from the air inlet of channel 147 increases.

A battery electronic control unit (ECU) or controller 120 is provided in the system 100. The ECU 120 may include and run a temperature control module 122, which may be a combination of software and hardware run or operated by a computer processor or similar processing equipment. The temperature control module 122 acts to send control signals 130 to the fan(s) 112 to operated the fan 112 to provide the inlet air 114 at one or more flow rates. In some embodiments, the fan 112 is geared and/or controlled via signals 130 to provide desired flow 114 based on the amount of heat generated by the operating battery pack 142 and/or the temperature of inlet air 114. To this end, the system 100 may include one or more air temperature sensors 132 for sensing a temperature of the inlet air 114 and sending a corresponding signal 134 to the temperature control module 122. Further, the system 100 may include one or more battery (or battery surface) temperature sensors 148 that function to sense the temperature of the battery surface 143 and send a corresponding signal 149 to the temperature control module 122. The ECU 120 may include memory 124 accessible by the module 122 and storing fan operating settings 126 and operating temperature ranges or settings 128 for the battery pack 142.

Then, during operation, the temperature control module 122 may act to process inlet air temperatures, battery surface temperatures, acceptable battery operating ranges (e.g., desired surface temperatures for pack 142 or its cells), fan settings for providing one or more flow rates, and/or other operating parameters to generated and transmit control signals 130. With regard to the presently described cooling system 100, it is useful to note that the configuration of the channel 147 makes it more likely that the battery ECU 120 will be able to manage the temperature at the battery surface 143 to be relatively uniform (e.g., within a smaller variance from inlet to outlet of the channel 147 compared with constant cross sectional shape/sized channels). The following discussion provides more specific examples of configuration of the shell 146 (or its inner surface structure/shape) to provide channels with cross sections with varying hydraulic diameter, Dₕ, and each of these channel arrangements may be used to provide the channel 147 of the system 100 of FIG. 1.

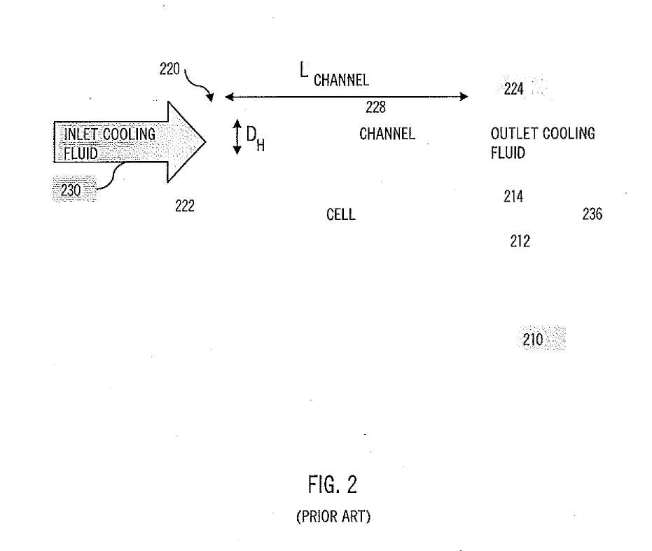

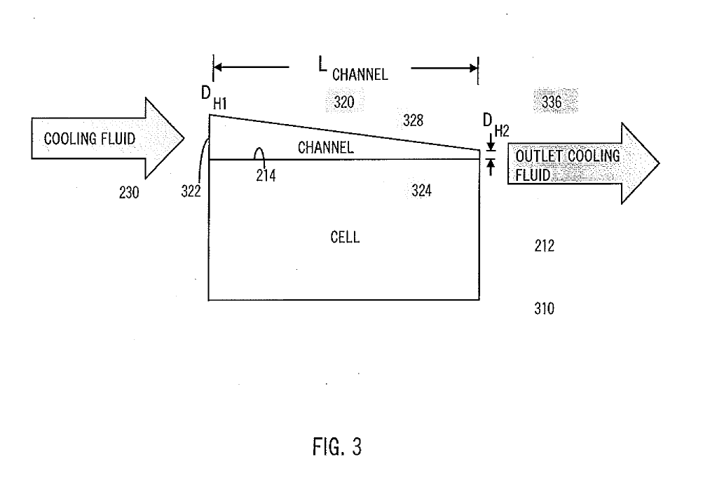

FIG. 2 illustrates a portion 210 of a vehicle battery cooling system (or cell and cooling channel pairing or arrangement). FIG. 3 illustrates, in contrast, a portion 310 of a vehicle battery cooling system (or cell and varying hydraulic diameter cooling channel pairing or arrangement) that provides an increasing heat transfer coefficient, h, within the cooling channel. The conventional battery cooling subsystem or arrangement 210 includes a vehicle cell 212 with a surface 214 that is exposed for cooling of the cell 212. A cooling channel 220 is provided with an inner, upper surface (or roof, top wall, or the like) 228 that defines a cross sectional dimension such as height that may be considered the hydraulic diameter, Dₕ, of the channel 220. The channel 220 has an open inlet or first end 222 for receiving inlet cooling fluid such as air flowing at a particular flow rate and at a first or inlet temperature. The channel 220 further includes an open outlet or second end 224 for discharging outlet cooling fluid such as air flowing at the system flow rate (e.g., a substantially constant flow rate may be used) and at a second or outlet temperature. In the conventional battery cooling subsystem, the hydraulic diameter, D₁₁, of the cooling channel is constant along the length, L_{channels}, of the channel 220 such that the cross sectional shape of the channel 220 is uniform along the channel 220 and surface 214 (e.g., a square or rectangular cross section in this example). Hence, the heat transfer coefficient, h, for the flowing cooling fluid is substantially constant or uniform along the surface 214 from the channel inlet 222 to the channel outlet 224.

In contrast, the battery cooling subsystem or arrangement 310 also includes the battery 212 with an exposed surface 214 but pairs this with a varying cross sectional shape channel 320. More specifically, the channel 320 may be provided or defined by a battery housing or battery cooling jacket or shell with a wall that defines an interior surface 328 (e.g., an upper surface or top wall of the channel 330 with vertical or slanted sidewalls, for example, further defining the channel 320). In this subsystem 310, cooling fluid such as air is input at a particular flow rate and temperature at a first open end or inlet 322 to the channel 320 and flows over the surface 214 of the cell 212, with heat being transferred from the surface 214, until is discharged as shown at 336 at a second higher temperature via channel second end or outlet 324. As shown, the inlet 322 of the channel 320 has a first hydraulic diameter, Dₕ₁, that is greater than the second hydraulic diameter, Dₕ₂, of the channel 320 at the outlet 324. The upper surface 328 may be planar as shown such that the varying of the channel's cross sectional dimension (i.e., hydraulic diameter) is linear along the length, L_{channel}, of the channel 214 (or from with increasing distance along the surface 214 from the inlet 322 of the channel 320). In other embodiments, though, the channel 320 may have any of a number of other differing profiles to providing tuning or varying of the hydraulic diameter of the channel 320. In any of these decreasing channel size cases, the heat transfer coefficient, h, for the flowing cooling fluid such as air varies along the surface 214 with increased distance from the inlet 322, and, more specifically, the heat transfer coefficient, h, increases with decreasing hydraulic diameter. This is desirable to provide more uniform temperature distribution on the surface 214 by increasing the heat transfer coefficient, h, of the cooling fluid in the channel 320 as the temperature of the cooling fluid increases thus reducing the difference between the temperature of surface 214 and the cooling fluid in channel 320.

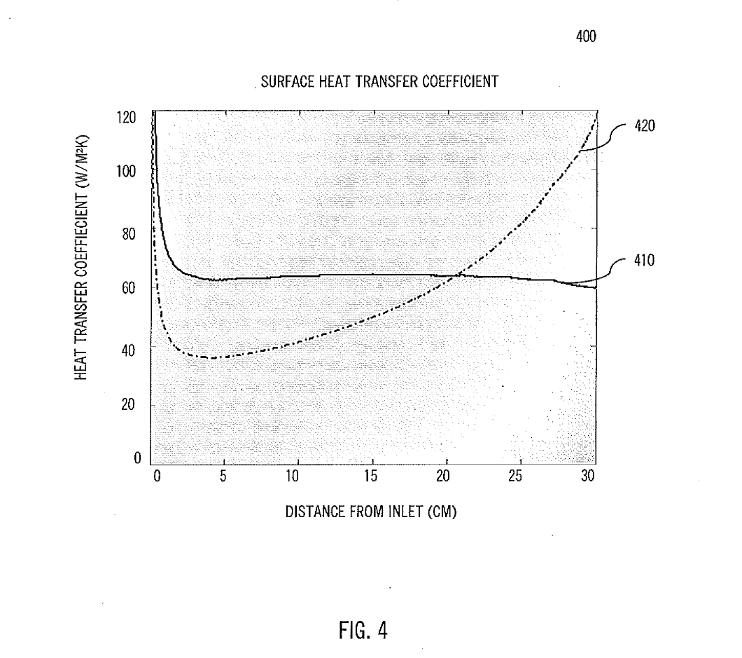

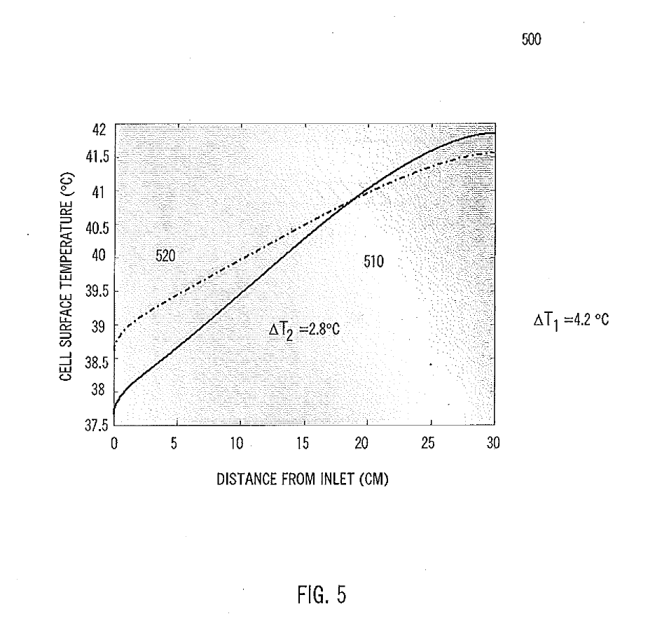

Both of these direct air cooling arrangements 210, 310 were tested with some of the relevant results being provided in FIGS. 4 and 5. In both arrangements or subsystems 210, 310, a similar cell 212 was used with a surface 214 exposed to inlet cooling fluid 230 flowing at a constant flow rate at a first or inlet air temperature. Specifically, a lithium ion cell typically of large HEV and EV batteries was provided for cell 212 and had cell dimensions of 450 mm by 300 mm by 5 mm, with the 300 mm dimension coinciding with cell surface 214 and length, L_{channel}, of channel 320. The cell 212 generated heat during operation/testing at a rate of 13.5 W/cell, and the cooling fluid 230, 236, 336 was air provided at a flow rate of about 3.81 cfm. The channels 220, 320 were both rectangular in cross sectional shape with the conventional channel 220 having a height or hydraulic diameter of 1 mm and a depth equal to about 5 mm times the number of cells in the battery pack 212. The decreasing size channel 320 had the same depth or width as channel 220 but had a first height or hydraulic diameter, Dₕ₁, of 2 mm and a second height or hydraulic diameter, Dₕ₂, of 0.5 mm. In FIGS. 2 and 3 the channel height is not to scale relative to the cell size for ease of illustration.

FIG. 4 provides a graph 400 comparing operational results with the subsystem 210 and subsystem 310 to cool cell(s) 212. In the graph, line 410 is the heat transfer coefficient profile for the constant hydraulic diameter channel 220 while line 420 is the heat transfer coefficient profile for the varying hydraulic diameter channel 320. The line 410 shows that when the hydraulic diameter is kept constant for a channel the heat transfer coefficient quickly stabilizes and remains relatively constant or uniform along the length of the channel from the channel inlet to the channel outlet. In contrast, line 420 shows that decreasing the channel height or hydraulic diameter of the channel with increasing distance from the air inlet of the channel causes the heat transfer coefficient to increase along the flow direction of the channel.

FIG. 5 provides a graph 500 of the cell surface temperature during testing of the battery cooling subsystems 210, 310. Line 510 represents the cell surface temperature in relation to distance from the inlet of the channel for the constant hydraulic diameter channel embodiment 210 while line 520 represents the cell surface temperature in relation to distance from the inlet of the channel for the varying (or decreasing) hydraulic diameter channel embodiment 310. The graph 500 also specifically shows that for this particular combination of cell(s) 212, coolant flow conditions, and channel configurations the difference in cell surface temperature at or near the channel inlet and outlet was reduced from 4.2° C. to 2.8° C. by using a decreasing hydraulic diameter. Similar results are likely achievable with other cell(s) and battery packs and flow rates as well as with a wide range of channel designs, with an important aspect being the decrease in the hydraulic diameter with increasing distance from the channel or coolant inlet.

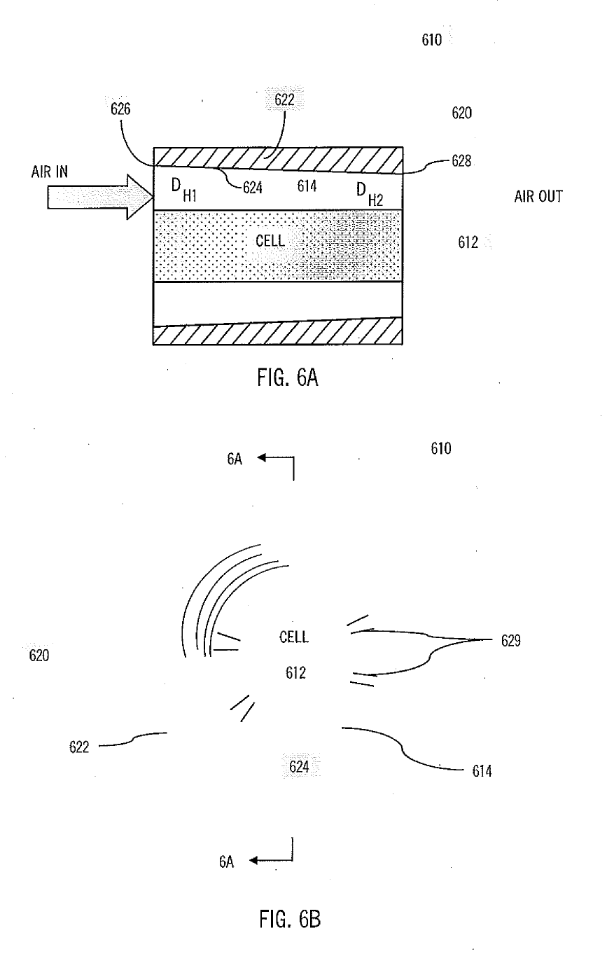

At this point, it may be useful to consider other arrangements of battery cooling subsystems (or channel/cell pairings) in which the concept of varying or decreasing hydraulic diameter may be successfully implemented to tune the heat transfer coefficient to achieve more uniform temperature distribution in a cell. FIGS. 6A and 6B show a battery cooling subsystem 610 for use in cooling a cylindrical cell 612. The cylindrical cell 612 is supported within a cooling jacket or shell 620 such as with struts/supports 629 extending from shell wall 622. The wall 622 includes an inner surface or wall 624 that defines (along with the outer cell surface 614) the cooling channel or airflow passageway for subassembly 610. The channel includes an inlet 626 at a first end and an outlet 628 at a second end.

Cooling fluid such as air is input to the channel defined by surface 624 via inlet 626 acts to transfer heat from the surface 614 of cell 612 to cool the cell 612 and then is discharged from the channel via outlet 628. The surface 624 a cylindrical cooling channel in which the cell 612 is positioned such and may be thought of as having a circular cross section shape defined by a diameter or a hydraulic diameter may be thought of as the distance between the cell surface 614 and shell interior surface 624 as shown in FIGS. 6A and 6B. The hydraulic diameter is decreasing in the subsystem 610 with the first, larger hydraulic diameter, Dₕ₁, shown at inlet 626 and the second, smaller hydraulic diameter, Dₕ₂, shown at the outlet 628 of the channel defined by surface 624. As with the profile of channel 320 in subsystem 310 of FIG. 3, the surface 624 is shown to decrease the size of the cross section of the cooling fluid channel in a linear manner.

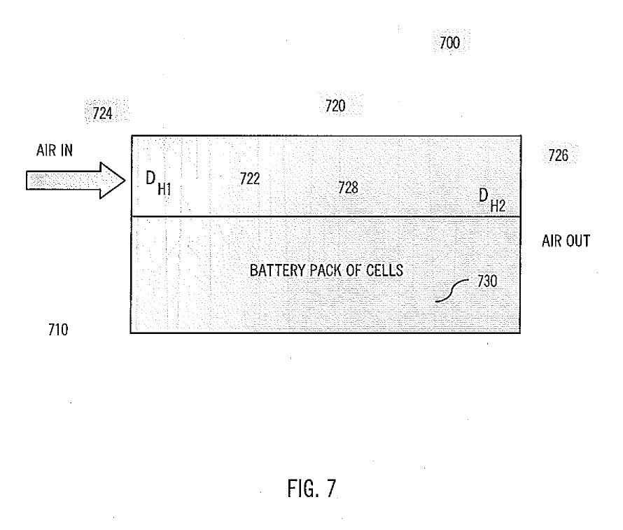

FIG. 7 illustrates another battery cooling subsystem 700 in which the hydraulic diameter of a cooling channel or passageway is varied non-linearly. As shown, the subassembly 700 includes a battery housing or tray 710 in which a battery pack or module of cells (such as prismatic, cylindrical, or other lithium ion or other battery-types) 730 are positioned and/or supported. The temperature of the cells 730 is managed or controlled in the subsystem 700 by providing a volume of cooling fluid such as air that is forced to flow over an exposed surface (e.g., direct contact cooling or simply direct cooling). A shell or wall 720 is provided as part of the housing 710 or as a separate component. The shell 720 includes an inner surface 722 that defines a cooling channel 728 to cause the inlet air to flow over the surface of the battery pack 730. The channel 728 has a first open end or inlet to receive the inlet cooling air and a second open end or outlet for discharging outlet or exhaust air after heat transfer with the surface of battery pack 730. The cooling channel 728 may be square or rectangular or have another cross sectional shape. As with the other cooling channels shown and discussed, the inlet 724 has a first hydraulic diameter, Dₕ₁, that is greater than the hydraulic diameter, Dₕ₂, at the outlet 726 of the channel 728. In other words, the channel has a decreasing hydraulic diameter along the flow path/direction of the coolant and with increasing distance from inlet 724. However, in contrast to other channels shown, the change in the hydraulic diameter from inlet 724 to outlet 726 is not linear in fashion but instead may be considered to be tapered or defined by a curve or parabolic function (or some other nonlinear function). As shown, the hydraulic diameter of the channel 728 is tuned such that the greater change or decrease occurs later in the channel 278 or is greater as the distance from the inlet 724 becomes greater. Such an arrangement may be useful for providing a significantly greater heat transfer coefficient, h, for the air flowing in the channel 728 nearer to the outlet 726 or where the temperature of the flowing air or other fluid is the highest (e.g., where the difference between the air and battery surface temperature is lowest).

With the teaching provided in this description, those skilled in the art will readily extend the specific examples of cooling channel configurations to numerous other configurations. These modifications and permutations are considered within the scope of this description and following claim sets. Further, it is expected that design choices such as a desire to limit pressure drop may define a limit for many battery cooling systems on the amount of temperature uniformity that is found to be acceptable for a particular application or advanced vehicle. For example, it may be desired to limit fan size to a particular value and the amount of decrease in the hydraulic diameter and, therefore, increase in heat transfer coefficient, along the length of the coolant channel may be limited to suit the fan capacity. Additionally, manufacturing requirements may urge use of the linear or more uniform decrease in hydraulic diameter with distance from the coolant channel inlet rather than a more complex pattern of changes or decreases in the hydraulic diameter (such as a channel with a hydraulic diameter that establishes a more complex, curved profile).

In the illustrated embodiments, the hydraulic diameter is typically the only channel cross sectional dimension that is varied with distance from the channel inlet. However, in some embodiments, a decreasing hydraulic diameter may be combined or used with an increasing contact or heat transfer surface area to achieve a desired heat transfer between the battery surface and the flowing air or other cooling fluid. For example, if the coolant channel is rectangular in shape defined in part by a top wall that sets the hydraulic diameter and by a pair of sidewalls, one or both of the sidewalls may be positioned relative to the channel such that the contact area or heat transfer area on the battery increases from the inlet to the channel to the outlet of the channel (e.g., one or both of the sidewalls may be angled outward when viewed from the inlet end of the channel).

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include modifications, permutations, additions, and sub-combinations to the exemplary aspects and embodiments discussed above as are within their true spirit and scope. For example, the above description describes cooling systems with cooling channels with varying hydraulic diameter to provide an increasing heat transfer coefficient, but it will be apparent that the concepts may be applied to heating systems where it is desired to heat an object's surface uniformly. Also, the materials used for the cooling shell or jackets or channel walls was not specified in detail as it is not believed to be limiting, but may be any material commonly used in cooling systems such as plastics that are easy to manufacture and light or metals and other materials with higher heat transfer coefficients. Further, the fan shown in FIG. 1 may also be positioned downstream from the outlet of the cooling channel to draw or pull the cooling fluid or air over the battery surface and/or may be supplemented with one or more additional fans upstream or downstream from the cooling channel. The term “battery” is intended to be construed broadly as the concepts described herein are believed applicable to nearly any energy storage device such as batteries, ultra-capacitors, and the like.

Further, the above description stresses the use of varying hydraulic diameters for cooling an energy storage device. However, those skilled in the art will readily understand that these same concepts and ideas may be used for providing improved heating of similar devices. As discussed in the background, it is often desirable to maintain a battery or other energy storage devices within a desired temperature range. Such thermal management may require cooling the energy storage device and/or it may involve heating the energy storage device to raise its temperature to fall within a desired operating range. Hence, the designs and configurations described above and shown in the accompanying figures may be used for heating simply providing a heating fluid such as forced air to flow through a thermal management shell rather than a cooling fluid. Therefore, the above description may be read with an understanding that the term “cooling” may be replaced generally by “heating” and the “battery cooling system” may be thought of as an “thermal or temperature management system for energy storage devices,” and it not believed necessary to repeat the above discussion to explain how heating is achieved as these will be apparent to those skilled in the arts of heating and cooling.

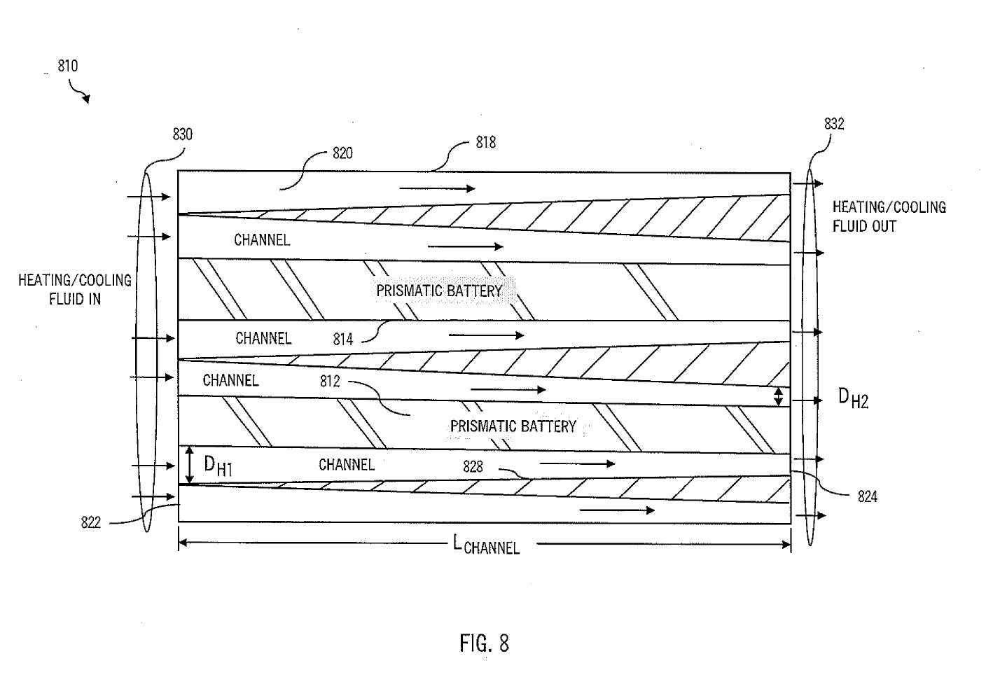

With this in mind, FIG. 8 illustrates a thermal management system 810 for use with energy storage devices such as prismatic batteries as shown. The system 810 includes a number of prismatic batteries 812 with exposed surfaces 814 that require cooling and/or heating to maintain their surface temperatures within desirable operating ranges. Specifically, the system 810 provides a jacket or shell 818 about the batteries 812. Channels 320 are defined adjacent the battery surfaces 814 with sidewalls 828 of the shell 818 that are sloped or slanted surfaces arranged to provide a first open end or inlet 822 of the channel 820 and a second open end or inlet 824. The channel inlet 822 has a hydraulic diameter, Dₕ₁, that is larger than the hydraulic diameter, Dₕ₂, of the channel outlet 824, and, during use, heat transfer fluid (e.g., heating or cooling fluid such as air) is forced by pumps/fans to flow through the channels 820 and inject or eject heat from the batteries 812 to manage their temperatures (e.g., to rise or lower the temperatures of the battery surfaces 814). The inlet fluid 830 may be at a first temperature and the outlet fluid 832 at a second temperature, with the first temperature greater than the second in a heating application and less than the second temperature in a cooling application. In some systems 810, both heating and cooling is provided as needed by selecting the inlet temperature (or changing the source of the fluid in 830 such as through the use of control valves or the like to take air/gas from a heater or from exhaust from a nearby component/system or from the surrounding environment). From this further example, it can be readily seen that the teaching provided herein applies to both heating and cooling applications with a heating/cooling fluid such as air and also may be used with nearly any energy storage device including a wide variety of battery designs.

1. A thermal management system for providing improved temperature distribution for batteries and other energy storage devices, comprising:
a fan moving fluid at a flow rate;
an energy storage device with an exposed surface; and
a heat transfer shell with an interior surface spaced apart from the exposed surface, wherein the interior surface defines a channel for the moving fluid to flow at the flow rate over the exposed surface from an inlet to an outlet of the channel and wherein the channel has a first hydraulic diameter at the inlet and a second hydraulic diameter smaller than the first hydraulic diameter at the outlet to the channel.

2. The system of claim 1, wherein a heat transfer surface area on the exposed surface is uniform within the channel from the inlet to the outlet.

3. The system of claim 1, wherein the fluid comprises air entering the channel at the inlet at a first temperature and exiting the channel at the outlet at a second temperature differing from the first temperature and wherein the system has a first heat transfer coefficient proximate to the inlet of the channel and a second heat transfer coefficient greater than the first heat transfer coefficient proximate to the outlet of the channel.

4. The system of claim 1, wherein the cell surface has a first temperature proximate to the inlet of the channel and a second surface temperature proximate to outlet of the channel and wherein the second temperature differs about 4° C. from the first temperature.

5. The system of claim 1, wherein the channel has a plurality of hydraulic diameters each decreasing in magnitude from the first hydraulic diameter at the inlet to the second hydraulic diameter at the outlet of the channel.

6. The system of claim 5, wherein the plurality of hydraulic diameters decrease in magnitude linearly from the inlet to the outlet of the channel.

7. The system of claim 1, wherein the channel has a cross sectional shape with a first area at the inlet and a cross sectional shape with a second area less than the first area at the outlet of the channel.

8. The system of claim 7, wherein the cross sectional shapes of the channel at the inlet and the outlet are each defined by a height measured from the cell surface to the interior surface of the cooling shell and wherein the height at the inlet is greater than the height at the outlet of the channel.

9. The system of claim 1, wherein the first and second hydraulic diameters have values selected such that a surface heat transfer coefficient proximate to the inlet of the channel is less than about 50 percent of a surface heat transfer coefficient proximate to the outlet of the channel.

10. A battery cooling system for managing temperature distribution in a vehicle battery, comprising:
a housing for receiving the vehicle battery; and
a flow channel defined by an interior surface of the housing, the interior surface spaced apart from the received vehicle battery and the flow channel having an inlet end for receiving cooling air flow and an outlet end for discharging the cooling air flow after contact with a surface of the received vehicle battery;
wherein the flow channel has a first hydraulic diameter proximate to the inlet end and a second hydraulic diameter proximate to the outlet end, the second hydraulic diameter being smaller than the first hydraulic diameter.

11. The system of claim 10, wherein the interior surface is configured to provide the flow channel with a plurality of hydraulic diameters and wherein the hydraulic diameters decrease in magnitude with increasing distance from the inlet end of the flow channel.

12. The system of claim 11, wherein the flow channel has a rectangular cross sectional shape and wherein the interior surface is substantially planar.

13. The system of claim 10, wherein the second hydraulic diameter has a value of less than 50 percent of a value of the first hydraulic diameter.

14. The system of claim 10, wherein the first and second hydraulic diameters have values selected such that a surface heat transfer coefficient proximate to the inlet end is less than about 50 percent of a surface heat transfer coefficient proximate to the outlet end of the flow channel.

15. A vehicle adapted for managing temperature distribution within battery cells, comprising:
a battery pack with at least one cell surface exposed for direct contact heat transfer;
a fan assembly operable to provide flowing air; and
a channel with an inlet for receiving the flowing air and an outlet for discharging the flowing air after the direct contact heat transfer with the cell surface, wherein the channel has a cross sectional shape defined by a dimension representing spacing of a channel upper wall from the cell surface, the cross sectional shape dimension being greater at the inlet than at the outlet.

16. The vehicle of claim 15, wherein the cross sectional shape dimension defines a hydraulic diameter for the channel and wherein the channel upper wall is configured such that the hydraulic diameter decreases along the cooling channel from the inlet to the outlet.

17. The vehicle of claim 15, wherein for a particular volume and inlet temperature of the flowing air the channel provides a surface heat transfer coefficient for the cell surface that increases along the channel from the inlet to the outlet such that the surface heat transfer coefficient is at least about twice as large at the outlet than at the inlet of the channel.

18. The vehicle of claim 17, wherein the cell surface has a temperature that is less than about 4° C. different proximate to the outlet than a temperature proximate to the inlet during use of the battery and operation of the fan assembly to provide the flowing air in the channel.

19. The vehicle of claim 15, wherein the cross sectional shape is rectangular including the channel upper wall defines one of the rectangular cross sectional shape.

20. The system of claim 15, wherein the battery pack comprises a plurality of cylindrical or prismatic lithium ion batteries.
